(19) United States
(12) Patent Application Publication
(10) Pub. No.: US 2017/0328528 A1
(43) Pub. Date: Nov. 16, 2017

(54) LAMP FOR THE INSTALLATION IN AN ELECTRIC CABINET, ELECTRIC CABINET AND OPTICAL DEVICE

(71) Applicant: Hoffmeister Leuchten GmbH, Schalksmühle (DE)

(72) Inventor: Oliver Hoffmeister, Lüdenscheid (DE)

(73) Assignee: Hoffmeister Leuchten GmbH, Schalksmuhle (DE)

(21) Appl. No.: 15/510,960

(22) PCT Filed: Sep. 15, 2015
(86) PCT No.: PCT/EP2015/071127

§ 371 Date: Jul. 31, 2017

(30) Foreign Application Priority Data
Sep. 15, 2014 (DE) 10 2014 013 655.8

(51) Int. Cl. F21S 4/28; F21V 5/02; F21V 5/04; F21V 33/00; H02B 1/30; F21Y 2103/10; F21Y 2115/10; F21W 131/301

(52) U.S. Cl. CPC F21S 4/28; F21V 5/04; F21V 5/02; F21V 33/0012; F21Y 2103/10; F21Y 2115/10; F21W 2131/301; H02B 1/306

(57) ABSTRACT

Lamp for the installation in an electric cabinet comprising at least one electric light source, and an optical device with at least two optical portions for transmitting and redirecting light emitted from said electric light source, wherein the redirection characteristics of one of the optical portions differs from the redirection characteristics of the other optical portion, and wherein the two optical portions are discrete from each other and integrally formed or connected.

The present invention refers to a lamp for the installation in an electric cabinet, an electric cabinet comprising such a lamp as well as an optical device for a lamp.

Electric cabinets, particularly for the accommodation of electric switches or other electric components require illumination for the purpose of installation and maintenance operations. It is therefore known from the prior art to install lamps inside an electric cabinet. An according lamp is known, for example, from document EP 1 670 107 B1. The electric cabinet lamp known from this prior art is well suitable for the illumination of the installed electrical components, such as electric switches or the like.

However, installation and maintenance operations not only require the illumination of the electrical components inside the electric cabinet, but also an area in front of the electric cabinet may require illumination. This is due to the fact that the personnel conducting any installation or service operations may at the same time be obliged to read relevant papers or documents or keep record, in particular, in handwritten form. Therefore, it is generally desirable to illuminate not only the inside of an electric cabinet, but also a reading area in front of an electric cabinet, in particular, in front of its opening door. A reading area could, for example, be illuminated by a further lamp, which however, requires additional costs for the installation and maintenance, and at the same time also requires additional handling for switching on and off.

In view of the above, it has been the objective for the present invention to provide a lamp for the installation in an electric cabinet, which provides improved illumination characteristics and may ensure sufficient illumination with reduced handling effort and reduced costs. It has also been an objective to provide an electric cabinet with an according lamp as well as an optical device for an according lamp.

With regard to the lamp, said objective has been solved by the features of independent claim 1. As regards the electric cabinet, said objective has been solved by the features of claim 15 and an according optical device is subject to claim 16.

According to the invention, a lamp for the installation in an electric cabinet comprises at least one electric light source, and an optical device with at least two optical portions for transmitting and redirecting light emitted from said electric light source, wherein the redirection characteristics of one of the optical portions differs from the redirection characteristics of the other optical portion, and wherein the two optical portions are discrete from each other and integrally formed or connected.

According to the invention, the optical device may be any device that allows transmission and redirection of light and may thus be formed out of any suitable material for the transmission and redirection of light, for example, glass or any suitable plastics material. By providing two optical portions with different redirection characteristics, it is possible to redirect the light, which is emitted from the electric light source, into different directions, particularly into directions, which substantially differ from each other. Thereby specific areas in the environment of the lamp may be illuminated for specific purposes. Accordingly, by providing a lamp with an optical device according to the present invention, the functionality of two different lamps may be provided by one single lamp, thereby reducing the installation and maintenance costs as well as the handling effort for switching on and off the light source required.

Furthermore, by arranging the optical portions discretely from each other, it is ensured that the two optical portions are distinguishable. In other words, a discrete arrangement of the two optical portions allows to functionally separate the optical portions and to assign a specific illumination task and/or function to each of the two optical portions. The functionality of the lamp may thereby be precisely aligned with regard to the different illumination functionalities. At the same time, by integrally forming or connecting the two optical portions, the integration of said optical device into a lamp for the installation in an electric cabinet may be conducted in a simplified manner. Also, costs for manufacturing and assembly of the lamp may thereby be reduced.

According to a preferred embodiment of the present invention, the optical portions redirect light emitted from said electric light source into different light patterns. By redirecting light into different light patterns, it is possible to realize a plurality of illumination functionalities, particularly independent from each other, as each light pattern may specifically be arranged for one illumination task. Preferably the light patterns have a substantially cone-like, cylindrical shape or ellipsoidal shape, wherein preferably each light pattern has a central axis, preferably being inclined towards the central axis of another light pattern. Preferably the central axes of two different light patterns form an angle of more than 10°, more than 20°, particularly more than 30°, more particularly less than 90° or less than 60°.

According to a further preferred embodiment, the light emitted from said electric light source is converged or diverged light. Preferably, said emitted light enters the said optical portions at the same entrance angle, wherein preferably different light beams emitted from the electric light source enter said optical portions at the same entrance angle and/or are oriented towards the optical device at the same angle. Thereby, the influence of the orientation of the light entering into the optical device, specifically its optical portions, may be minimized and/or purposefully considered for the arrangement and/or the design of the optical portions.

According to a further preferred embodiment, a light beam oriented at a specific angle relative to the optical device is redirected by one of the optical portions to an extent, which is different to the extent of redirection caused by the other optical portion with regard to a light beam being oriented at the same specific angle. Therefore, the redirection characteristics of the optical portions may differ in such a way that also light beams entering at the same angle relative to said optical portions or being arranged at the same angle relative to the entire optical device, are redirected in a different way. Thereby, the illumination characteristics of the lamp may more individually be adjusted with regard to different illumination tasks.

According to a further preferred embodiment of the lamp, at least one of the optical portions causes a redirection of light due to refraction and/or reflection. Preferably one of the optical portions causes a redirection of light due to refraction and the other optical portion causes a redirection of light due to reflection. By redirecting light by means of refraction, the illumination intensity may be varied, whereas by merely reflecting the light, chromatic aberration may substantially be avoided. Thus, different redirectional effects may be implemented for different illumination purposes.

According to a further preferred embodiment of the lamp, at least one of the optical portions has a light diverging characteristic and/or wherein at least one of the optical portions has a light converging characteristic and/or wherein at least one of the optical portions is free of diverging or converging characteristic. Thus, light may be diverged or converged by at least one of the optical portions. Likewise also a portion without any diverging or converging characteristics may be implemented.

According to a further advantageous embodiment, at least one of the optical portions comprises a prism and/or prism structure and/or wherein at least one of the optical portions comprises a lens and/or lens structure. By combining a prism or prism structure with a lens or lens structure, the individual characteristics for the redirection of light may be suitably combined. An optical prism allows the redirection of light without or significantly without refraction, whereas an optical lens allows converging or diverging light and therewith influencing the intensity of illumination.

Preferably, a plurality of optical portions are provided, in particular, more than three optical portions, wherein preferably three optical portions comprise a light converging or diverging lens.

According to yet a further embodiment of the lamp, the optical portions are preferably provided on a single optical body. By providing the optical portions on a single optical body, the manufacturing of the optical device may be simplified and also its assembly on a lamp casing may be handled with reduced effort. Preferably, said optical body has a plate-shaped form. More preferably, one of the optical portions is preferably surrounded by the other optical portion along a plane orientation of the optical body. In particular, an optical portion comprising a lens or a lens structure may be surrounded by another optical portion which comprises a prism or prism structure. By surrounding one of the optical portions by one of the other optical portions, it is possible to provide different redirection functionalities within a reduced constructional space and at the same time optimize also the use of the light emitted from said electric light source for the desired redirection into different light patterns.

According to yet a further embodiment, the plurality of optical portions comprises a plurality of lenses and at least one prism or prism structure, preferably with a plurality of prisms. More preferably three lenses are, along a plane orientation of the optical device, and more particular, along a plane orientation of its optical body, surrounded by an optical prism portion. The lenses are preferably separated from each other by the optical prism portion.

By providing a plurality of lenses, the converging or diverging characteristics specifically desired for one of the illumination functionalities of the lamp may be further improved. While arranging the plurality of lenses at different portions on the optical device, said different lenses may also redirect light from different portions of the electric light source, therewith potentially intensifying the illumination of a desired reading space. The separation of the lenses by an optical prism portion allows the distance between different lenses to be increased, without significantly affecting the redirection properties of the optical prism portion.

According to yet a further embodiment of the lamp, a plurality of optical portions comprise a plurality of lenses, which preferably have parallel optical axes or which have optical axes preferably inclined towards each other. Preferably, the lenses are configured to converge or diverge light into a light cone or diverge light into a light cylinder or into an ellipsoid. More preferably, the light cones, the light cylinders or light ellipsoids of at least two different lenses overlap at least along a spatial reading portion. By arranging the optical axes of the plurality of lenses parallel to each other, a spatial reading portion with an elongated shape may be achieved. Contrary to this, by arranging the optical axes of the plurality of lenses inclined towards each other, it may be possible to achieve higher illumination intensities in a desired spatial reading portion, in particular, by overlapping the light patterns of the plurality of lenses.

In a further preferred embodiment of the lamp, the electric light source is arranged within or substantially within the focal point of at least one lens. More preferably, the electric light source crosses the focal point at least one lens, preferably the focal points of all lenses. The illumination intensity may thereby be improved.

According to an embodiment of the present invention, the optical device may be manufactured from a translucent and/or transparent material. Also, the surfaces of the optical device may be clear, thereby providing improved transmission properties. Likewise, the optical device or only surface portions thereof may be matted or frosted or satin-finished. It is particularly advantageous to roughen the side face of the optical device facing the electric light source. Therewith, the effect of chromatic aberration may be minimized and the different light patterns may have a soft transition. Also, the optical may be colored, in case a specific illumination color is desired. More preferably, the side face of the optical device facing the electric light source may be planar or substantially planar.

According to a preferred embodiment, the electric light source has an elongated shape and/or is extended along a line, wherein the electric light source preferably comprises a plurality of illuminants, particularly LEDs, which are preferably arranged along a line. More preferably, the electrical light source comprises a plurality of illuminants arranged along a plurality of lines, preferably each line comprising a plurality of LEDs and/or each line of illuminants is assigned to at least one optical portion, more preferably assigned to different optical portions. The different illumination tasks may thereby be implemented by a specific choice of LEDs. It is particularly advantageous to provide two different lines of illuminants, wherein one of the lines is shorter than the other line, and wherein more preferably, the shorter line of illuminants provides a smaller luminous power than the longer line of illuminants.

According to yet a further embodiment of the lamp, the at least one electric light source and/or at least one of the optical portions are configured to illuminate, in an installed state of the lamp, a wall portion or a vertical surface portion being spaced apart from the lamp at a distance between 100 mm to 600 mm, particularly between 140 mm and 500 mm, more particularly 140 mm or 500 mm. Preferably, the wall portion or vertical surface to be illuminated has a width of at least 600 mm, particularly more than 800 mm, more particularly 950 mm or more. More preferably, the height of the wall portion or vertical surface amounts to at least 1,500 mm, particularly more than 750 mm, particularly 2,000 mm or more. An according wall portion or vertical surface may for example be the back wall portion of an electric cabinet, to which electrical components, such as electrical switches are attached. By suitably illuminating an according wall portion or vertical surface, any installation or maintenance operations may be conducted with improved security.

Preferably, in this case, the maximum of illumination intensity at a distance of less than 150 mm from the wall portion or vertical surface is achieved in the upper third of the wall portion or vertical surface. In contrast, at a distance from the wall portion or vertical surface of 500 mm and more the maximum illumination intensity is achieved in the lower half of the wall portion or vertical surface. In both cases, sufficient illumination for an improved security of installation and maintenance operation of electrical components inside an electrical cabinet may be provided.

According to yet a further advantageous embodiment, the at least one electric light source and/or at least one of the optical portions are configured to illuminate in an installed state of the lamp, a spatial portion, particularly for reading. Preferably, the spatial portion is spaced apart from the lamp in a vertical orientation with a distance between 1,000 mm and 1,500 mm, more particularly 1,250 mm. More preferably, the spatial portion is spaced apart from the lamp in a horizontal orientation with a distance between 125 mm and 75 mm, even more preferably at a distance of 100 mm. Furthermore the spatial portion may have a width between 150 mm and 250 mm, preferably of 200 mm. An according spatial portion is well suitable as a reading portion, thereby improving the comfort of reading and keeping record of any documentation during any required installation or maintenance procedures inside the electric cabinet.

According to a further aspect of the present invention, an electric cabinet, in particular for the accommodation of electric switches, comprises a lamp with any one of the above-described features. An according electric cabinet may be operated with increased comfort, as sufficient illumination of the inside of the electric cabinet is provided on the one hand and on the other hand, also the illumination of a spatial reading portion outside the electric cabinet may be established.

Therefore, even in an arrangement of the electric cabinet, which is disadvantageous with regard to external light, any reading or documentation work of an operator may be conducted under ideal illumination circumstances. Security and comfort of the operation of an according electric cabinet is thereby improved.

According to yet another aspect of the present invention, an optical device, in particular for a lamp with the above-described features comprises at least two optical portions for transmitting and redirecting light from an electric light source, wherein the redirection characteristics of one of the optical portions differs from the redirection characteristics of the other optical portion, and wherein the two optical portions are discrete from each other and integrally formed or connected. An according optical device is suitable for the arrangement in a lamp, which shall provide a plurality of illumination tasks, such as providing a basic illumination of the inside of a cabinet, and further to this, the illumination of a specific reading portion.

Further embodiments of the present invention result from combinations of the features disclosed in the claims, the specification and the drawings. Embodiments of the present invention will be described in the following with reference to the drawings.

### BRIEF DESCRIPTION OF THE DRAWINGS

FIG. 1 is a perspective exploded view of a lamp for the installation in an electric cabinet according to an embodiment of the present invention.

FIG. 2 is a perspective view of an optical device according to an embodiment of the present invention.

FIG. 3 is a schematic side view of an optical device according to an embodiment of the present invention.

FIG. 4 is a schematic plan view of an optical device as well as an electric light source according to an embodiment of the present invention.

FIG. 5 is a schematic cross-sectional side view of a lamp according to an embodiment of the present invention.

FIG. 6 is a schematic front view of a lamp illustrating its illumination characteristic from a front view.

FIG. 7 is a schematic side view of a lamp showing its illumination characteristic from a side view.

FIG. 8 is an isolux diagram corresponding to a lamp according to an embodiment of the present invention.

FIG. 9 is a further isolux diagram corresponding to a lamp according to an embodiment of the present invention.

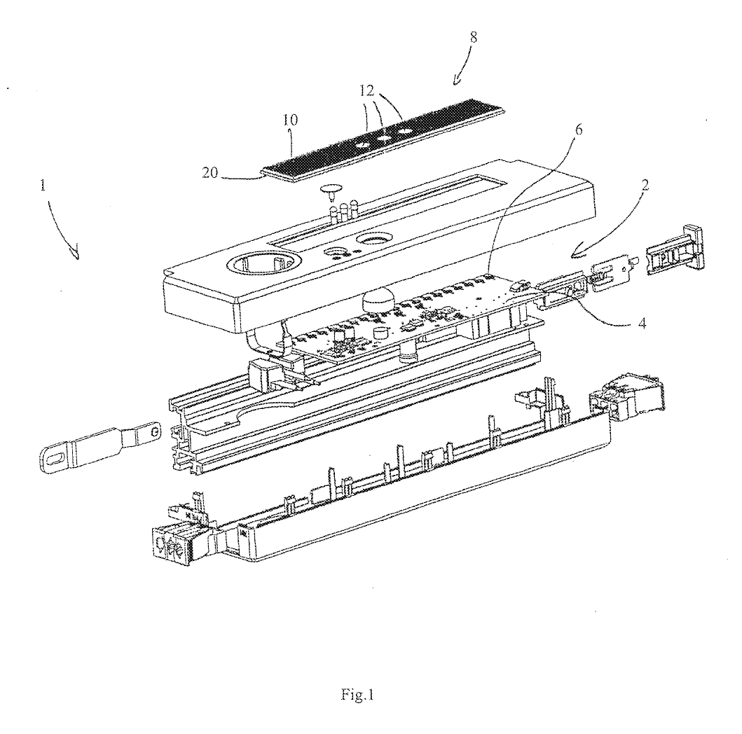

FIG. 1 is an exploded view of a lamp 1 for the installation in an electric cabinet (not shown here). The lamp 1 comprises an electric light source 2. Electric light source 2 may be provided in the form of a circuit board 4, on which illuminants 6 are arranged, preferably along a line.

Furthermore, the lamp 1 comprises an optical device 8 with at least two optical portions 10 and 12 for transmitting and redirecting light emitted from said electric light source 2. The redirection characteristic of optical portion 10 differs from the redirection characteristic of the other optical portion 12 or any one of the optical portions 12. Furthermore, the two optical portions 10 and 12 are discrete from each other and integrally formed or connected. Particularly, the optical portions 10 and 12 may be provided on an optical device 8, which is formed by a single optical body 20.

The optical portion 10 redirects light emitted from said electric light source 2 into a light pattern, which is different from the optical light pattern of optical portion 12 or any one of the optical portions 12. In particular, a light beam emitted from the electric light source 2 being oriented at a specific angle relative to the optical device 8 is redirected by optical portion 10 to an extent, which is different to the extent of redirection caused by the other optical portion 12 with regard to a light beam being oriented at the same specific angle.

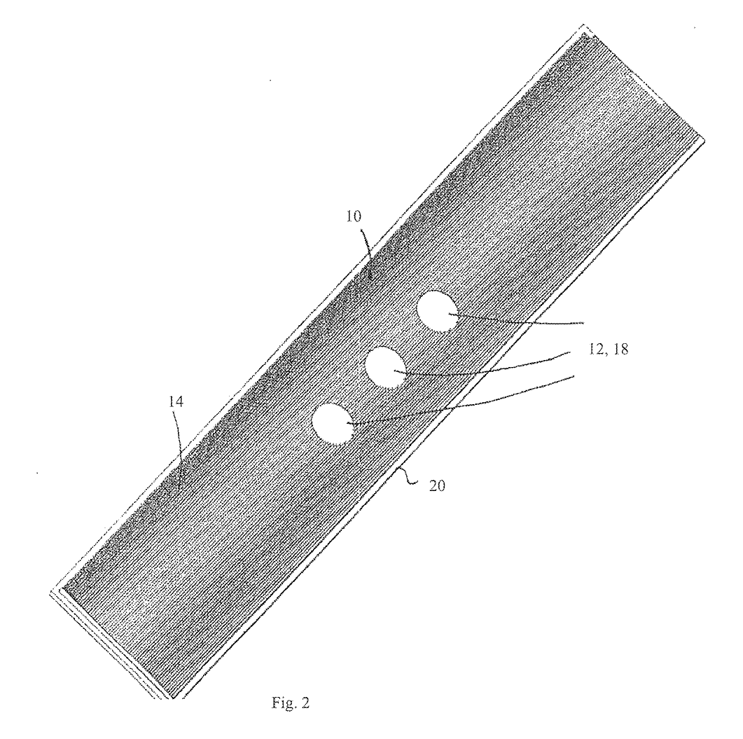

FIG. 2 shows a perspective view of an optical device 8 for lamp 1 according to an embodiment of the invention. Optical device 8 comprises an optical body 20 with side faces 21a and 21b. Side face 21a is faced toward the electric light source 2 and may be substantially planar. Also, side face 21a may be roughened. Side face 21b faces away from the electric light source 2. The specific shapes of the optical portions may be formed on side face 21b.

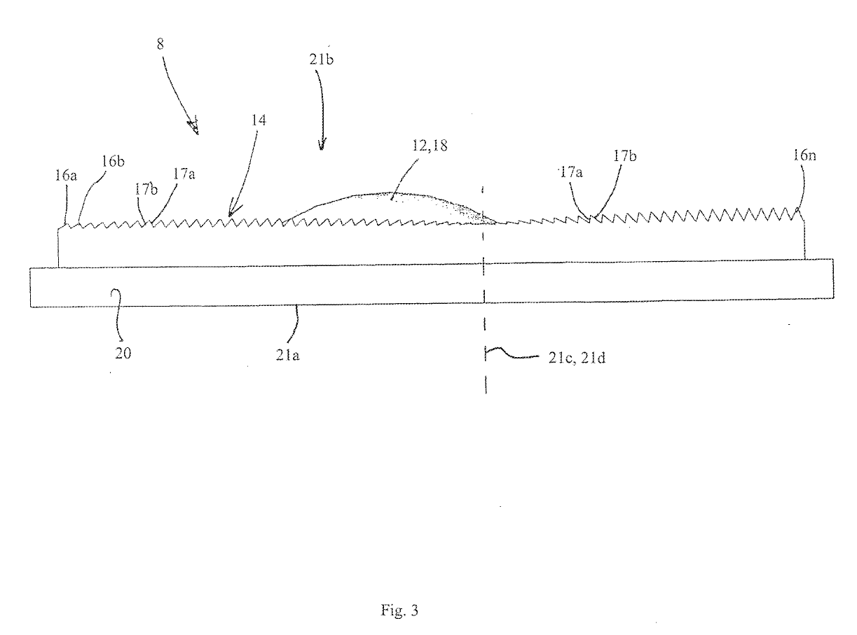

In particular, optical portion 10 comprises a prism structure 14 with a plurality of prisms 16a to 16n, as may be comprehended from FIG. 3. Each prism 16a to 16n may be oriented in parallel to a longitudinal extension of the electric light source 2, in particular parallel to a line 22 of the electric light source 2. The precise form of each prism 16a to 16n may vary in order to achieve a specifically desired redirection characteristic of optical portion 10. Each prism 16a to 16n may have a triangular cross-section with edges 17a and 17b, wherein the lengths of the edges 17a and 17b of an according triangular may vary between the prisms 16a to 16n.

The variations in the shapes of prisms 16a to 16n may be described with regard to a reference line 21c of the optical device 8. Reference line 21c indicates a plane 21d, which extends in parallel to prisms 16a to 16n. The electric light source 2, particularly the line 22 of the electric light source 2 may be positioned along said plane 21d. The length of edges 17a facing said plane 21d may increase with increasing distance from said plane 21d. At a distance from said plane 21d, the length of edges 17a facing said plane 21d may decrease again.

Further to this, three further optical portions 12 are provided, each one of which comprising a light converging or diverging lens 18. Each Lens 18 may be formed convex to the outside, thus in direction away from the electric light source 2. The lenses 18 may be positioned aligned with a line 24 of the light source 2.

The optical portions 10 and 12 are provided on a single optical body 20, which has a plate-shaped form. As shown in FIG. 2, the lenses 18 are surrounded by the prism structure 14 along a plane orientation of the optical body 20, wherein the lenses 18 are particularly separated from each other by the optical prism structure 14. Preferably, the lenses 18 are configured to converge or diverge light into a light cone and/or into an ellipsoidal shape, whereas the optical axes of the lenses 18 are preferably inclined towards each other. Thereby, it is possible that the light cone or ellipsoid created by lenses 18 overlap at least along a spatial reading portion.

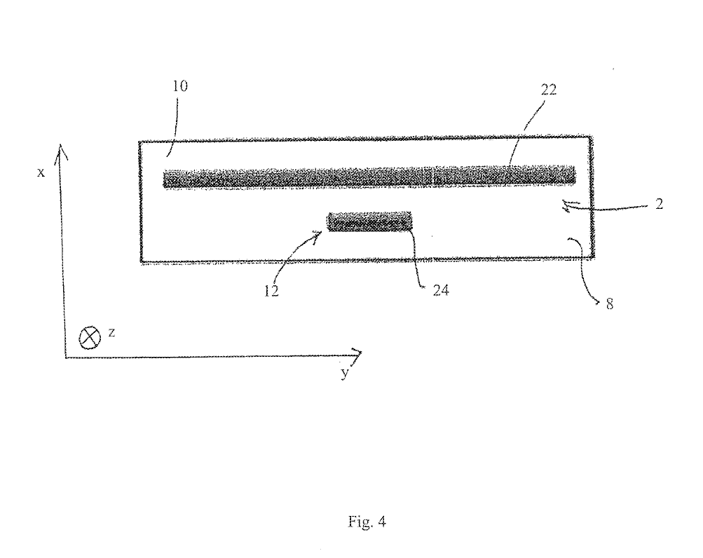

FIG. 4 schematically shows a lamp 1 with an electric light source 2 and an optical device 8 in a plan view. It is schematically illustrated that the electrical light source 2 has an elongated shape or is extended along a line. Particularly, the electric light source 2 comprises two separate lines 22 and 24, along which a plurality of illuminants, such as LEDs, is arranged. It may be seen that line 22 is longer than line 24. Furthermore, line 24 is assigned to optical portion 12, whereas line 22 is assigned to optical portion 10.

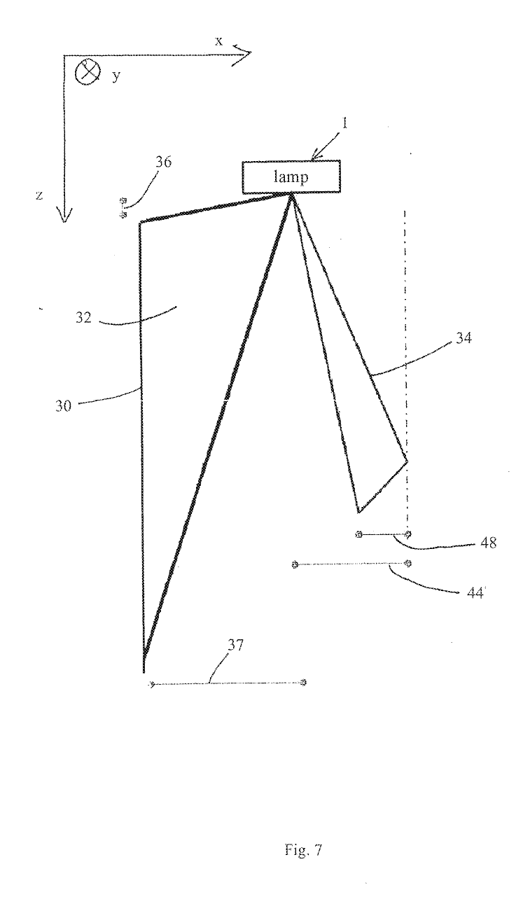

For explanatory purposes, axes X, Y and Z have been marked in FIG. 4, whereas axis Z extends into the plane of the illustration. The arrangement of electric light source 2 and the optical device 8 is chosen such that light emitted from line 22 of electric light source 2 is redirected by optical portion 10 in a positive X and Z direction. In contrast, light emitted from line 24 is redirected by optical portion 12 in a negative X direction and a positive Z direction. This will become apparent in more detail with reference to FIG. 7 below. The length of the optical device 8 (optical body 20) along the Y direction may for example be 100 mm, the widths of the optical device 8 along an X direction may for example be 32 mm.

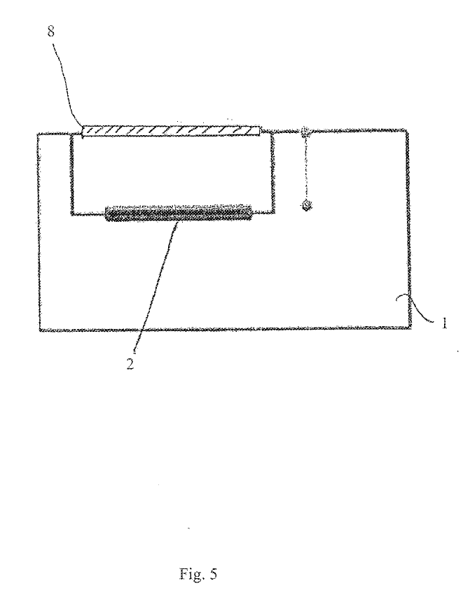

FIG. 5 shows a schematic cross-sectional view of the lamp 1. It may be comprehended that the electric light source 2 is positioned at a distance relative to the optical device 8 within the casing of the lamp 1. The distance between the electric light source 2 and the optical device 8 may for example be 7 mm to 11 mm, preferably 9 mm. Said distance may be chosen such that the electric light source, in particular, its illuminants or line of illuminants are arranged within focal points of the lenses 12 or substantially cross through said focal points.

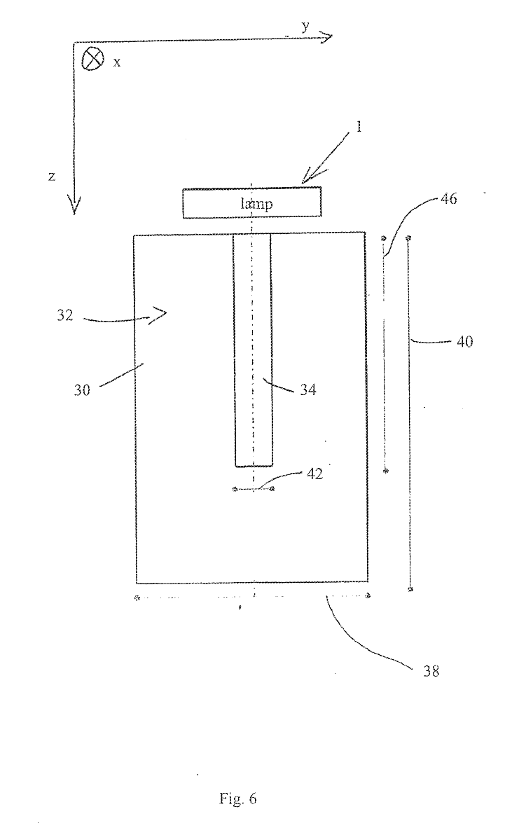

FIG. 6 shows a schematic illustration of the illumination characteristics of lamp 1 when viewed in an X direction. For the sake of clarity, the coordinate system of FIG. 4 has logically been transferred to FIG. 6 and also to FIG. 7, which schematically shows the illumination characteristics of lamp 1 when viewed in a Y direction of the coordinate system.

It may be comprehended from FIGS. 6 and 7 that lamp 1 is arranged above (along the Z-direction) a vertical wall portion or surface 30 to be illuminated. The vertical distance 36 between lamp 1 and vertical wall portion or surface 30 to be illuminated may for example amount to 50 mm. Said vertical wall portion or surface 30 may have a width 38 in the Y direction of 950 mm, for example. The height 40 of the vertical wall portion or surface 30 may for example amount to 2000 mm. Furthermore, lamp 1 may be positioned at a horizontal distance 37 (along the X-direction) from wall portion or surface 30. Lamp 1 may for example be arranged at a horizontal distance 37 to wall portion or surface 30 of 100 mm to 600 mm, particularly between 140 mm and 500 mm, more particularly 140 mm or 500 mm.

The illumination of wall portion or surface 30 may specifically be achieved by light redirected from optical portion 10, which particularly comprises a prism structure 14. Thus, the illumination task of optical portion 10 may rather be considered as illuminating a comparably large area. For this purpose, the redirection characteristics of optical portion 10 are configured such that a light pattern 32, which is indicated in FIGS. 6 and 7, is achieved.

In contrast, the electric light source 2 as well as the redirection characteristics of the optical portion 12 are configured such that light pattern 34 is established, as also shown in FIGS. 6 and 7. Light pattern 34 may have a much smaller width 42 in Y-direction than light pattern 32, for example, a width 42 of 200 mm. Furthermore, light pattern 34 is directed away from wall 30 and thus in a positive X-direction. Light pattern 34 may have a cone-like shape, with a spatial reading portion being arranged at a distance 44 from lamp 1 of at least 75 mm, preferably of 100 mm, in an X-direction, and at a distance 46 of 1250 mm in Z direction. The width 48 of a spatial reading portion in an X-direction may amount to at least 50 mm.

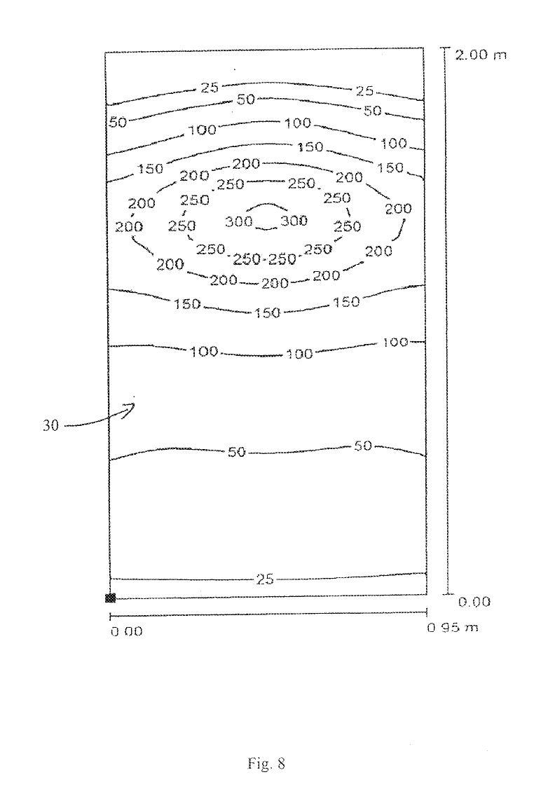

From FIG. 7 it may be comprehended that light patterns 32 and 34 are directed in different directions with regard to the YZ-plane, said YZ-plane being orthogonal to the X-axis. Also, it is apparent from FIG. 8 that the light patterns 32 and 34 may be symmetrical with regard to XZ-plane, said XZ-plane being orthogonal to the Y-axis. Light patterns 32 and 34 may be arranged that they do not overlap.

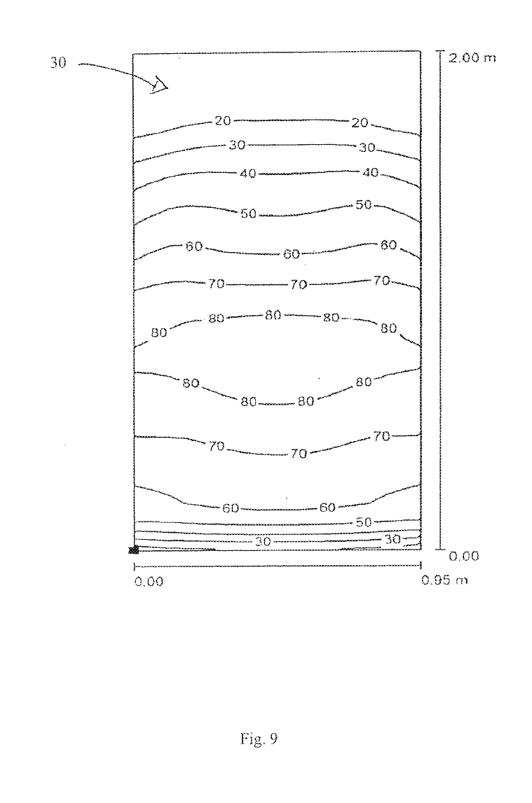

FIGS. 8 and 9 show different isolux diagrams corresponding to the illumination characteristics of a lamp 1 with different distances to a wall portion or surface 30. The isolux diagram shown in FIG. 8 corresponds to an installation distance of 140 mm between lamp and wall. It may be seen that the illumination maximum is arranged in the upper third of the illuminated wall portion or surface 30. It may be seen that the illuminance has a greater gradient when moving upwards from the maximum, as compared with the gradient of illiminance when moving in a downwards direction of the illumination maximum. FIG. 9 shows an isolux diagram corresponding to the illumination characteristics of a lamp when installed at a distance of 500 mm between the lamp 1 and the wall or surface 30. In FIG. 9, it may be seen that the illumination maximum is arranged in the lower half of the illuminated surface 30, wherein the illumination maximum is significantly lower with regard to its absolute value as compared to the illumination maximum shown in the isolux of FIG. 8. Finally also from isolux diagrams in FIGS. 8 and 9 it may be comprehended that the light patterns 32 and 34 may be symmetrical with regard to XZ-plane, said XZ-plane being orthogonal to the Y-axis.

1. Lamp for the installation in an electric cabinet comprising
at least one electric light source, and
an optical device with at least two optical portions for transmitting and redirecting light emitted from said electric light source,
wherein the redirection characteristics of one of the optical portions differs from the redirection characteristics of the other optical portion, and
wherein the two optical portions are discrete from each other and integrally formed or connected.

2. Lamp according to claim 1, wherein the optical portions redirect light emitted from said electric light source into different light patterns.

3. Lamp according to claim 1, wherein a light beam oriented at a specific angle relative to the optical device is redirected by one of the optical portions to an extent, which is different to the extent of redirection caused by the other optical portion with regard to a light beam being oriented at the same specific angle.

4. Lamp according to claim 1, wherein at least one of the optical portions causes a redirection of light due to refraction and/or reflection.

5. Lamp according to claim 1, wherein at least one of the optical portions has a light diverging characteristic and/or wherein at least one of the optical portions has a light converging characteristic and/or wherein at least one of the optical portions is free of a diverging or converging characteristic.

6. Lamp according to claim 1, wherein at least one of the optical portions comprises a prism and/or a prism structure and/or wherein at least one of the optical portions comprises a lens and/or a lens structure.

7. Lamp according to claim 1, wherein the optical portions are preferably provided on a single optical body.

8. Lamp according to claim 1, wherein the optical device may be manufactured from a translucent and/or transparent material or wherein the optical device is matted, frosted or satin-finished.

9. Lamp according to claim 6, wherein the plurality of optical portions comprises a plurality of lenses and at least one prism or prism structure.

10. Lamp according to claim 1, wherein a plurality of optical portions comprise a plurality of lenses, which preferably have parallel optical axes or which have optical axes preferably inclined towards each other.

11. Lamp according to claim 1, wherein the electrical light source is arranged within or substantially within the focal point of at least one lens and/or wherein the electrical light source crosses the focal point of at least one lens, preferably the focal points of all lenses.

12. Lamp according to claim 1, wherein the electrical light source has an elongated shape and/or is extended along a line, wherein the electrical light source preferably comprises a plurality of illuminants, particularly LED-lights, which are preferably arranged along a line.

13. Lamp according to claim 1, wherein the at least one electric light source and/or at least one of the optical portions are configured to illuminate, in an installed state of the lamp, a wall portion or a vertical surface portion being spaced apart from the lamp at a distance between 100 mm to 600 mm, particularly between 140 mm and 500 mm, more particularly 140 mm or 500 mm, the wall portion or vertical surface to be illuminated having a width of at least 600 mm, particularly more than 800 mm, more particularly 950 mm or more, and a height of at least 1500 mm, particularly more than 1750 mm, particularly 2000 mm or more.

14. Lamp according to claim 13, wherein the maximum of illumination intensity at distance of less than 150 mm from the wall portion or vertical surface is achieved in the upper in the upper third of the wall portion or vertical surface and/or wherein the maximum of illumination intensity at distance of 500 mm and more from the wall portion or vertical surface is achieved in the lower half of the wall portion or vertical surface.

15. Lamp according to claim 1, wherein the at least one electric light source and/or at least one of the optical portions are configured to illuminate, in an installed state of the lamp, a spatial portion, particularly for reading, the spatial portion being spaced apart from the lamp in a vertical orientation with a distance between 1000 mm and 1500 mm, more particularly 1250 mm, and/or wherein the spatial portion being spaced apart from the lamp in a horizontal orientation with a distance between 125 mm and 75 mm, preferably at distance of 100 mm, and/or wherein the spatial portion having a width between 150 mm and 250 mm, preferably of 200 mm.

16. Electric cabinet, in particular for the accommodation of electric switches, comprising a lamp according to claim 1.

17. Optical device, in particular for a lamp according to claim 1, comprising
at least two optical portions for transmitting and/or redirecting light from an electric light source,
wherein redirection characteristics of one of the optical portions differs from the redirection characteristics of the other optical portion, and
wherein the two optical portions are discrete from each other and integrally formed or connected.

18. Lamp according to claim 2, wherein a light beam oriented at a specific angle relative to the optical device is redirected by one of the optical portions to an extent, which is different to the extent of redirection caused by the other optical portion with regard to a light beam being oriented at the same specific angle.

19. Lamp according to claim 2, wherein at least one of the optical portions causes a redirection of light due to refraction and/or reflection.

20. Lamp according to claim 3, wherein at least one of the optical portions causes a redirection of light due to refraction and/or reflection.
